(19) United States
(12) Patent Application Publication
(10) Pub. No.: US 2016/0072957 A1
(43) Pub. Date: Mar. 10, 2016

(54) Call Center Calling Apparatus And Method

(71) Applicant: Voicecom Telecommunications LLC, Alpharetta, GA (US)

(72) Inventor: Sean Gordon, Alpharetta, GA (US)

(21) Appl. No.: 14/834,555

(22) Filed: Aug. 25, 2015

Related U.S. Application Data
(60) Provisional application No. 62/043,134, filed on Aug. 28, 2014.
(60) Provisional application No. 62/057,475, filed on Sep. 30, 2014.

(51) Int. Cl. H04M 3/56; H04M 3/51; H04L 29/06; H04M 3/523

(52) U.S. Cl. CPC H04M 3/568; H04M 3/5232; H04M 3/5233; H04M 3/5183; H04L 65/1006; H04L 65/403

(57) ABSTRACT

A call center having a telephony server configured for a caller to hold two-way telephone conferences with a plurality of contacts in sequence, in which the telephony server initiates a call to the contact, and upon establishing a connection with the contact joins the connection to a conference bridge with the caller, disengages the connection to the conference bridge upon disconnection of the call by the contact, and initiates a subsequent call to another contact while maintaining the caller in connection with the conference bridge.

### TECHNICAL FIELD

The present invention relates to call center apparatus and methods. More particularly, the present invention relates to apparatus and methods for telephone call processing by which call center personnel initiate and conduct telephone calls with contacts.

### BACKGROUND OF THE PRESENT INVENTION

Call centers provide personnel who make telephone calls to prospective customers for sales of goods and services, to provide technical support to customers, or to make solicitation and/or informational calls to contacts. In some call center systems, the callers practice a click and dial procedure in which the caller selects the contact to reach and directs a telephone system to place a telephone call to the selected contact. Another system provides a more centralized approach, in which a caller directs the call to the selected contact and upon answering of the call by the contact, the caller directs to the call to a selected representative for handling the substance of the call. While these systems provide for call center communications to contacts, there are efficiency drawbacks to such that detract from the benefits of call center services and may lead to hang-ups or dropped connections by the contacts.

Accordingly, there is a need in the art for improved processing of telephone calls handled by call center personnel in reaching contacts. It is to such that the present invention is directed.

### SUMMARY OF THE INVENTION

The present invention meets the need in the art with an apparatus configured for automated connection (joining) of calls by a caller with a plurality of contacts sequentially through a telephony server having a conference bridge, a first outgoing call to the caller to establish a first connection and joined to the conference bridge, and at least one second outgoing call to a contact from a plurality of contacts to establish a second connection and selectively joined to the conference bridge with each of the plurality of second connections selectively joined following disconnection of a preceding second connection while maintaining the first connection, for two-way communications between the first connection and the at least one second connection joined to the conference bridge in sequence, which conference bridge receives audio signals from the first connection and the at least one second connection, mixes the audio signals thereof, and distributes the mixed audio signals to the first connection and the at least one second connection joined in the conference bridge.

In yet another aspect, the caller may determine whether the contact meets pre-determined criteria for participation in the conference bridge by a specialty participant, and upon signaling by the caller, a third outgoing call to the specialty participant to establish a third connection and joined to the conference bridge, and the first connection thereafter disconnected from the conference bridge.

In yet another aspect, the present invention provides a method of operating a call center for conducting two-way telephone conferences between a caller and a plurality of contacts in sequence, comprising the steps of:

(a) initiating through a telephony server a first outgoing call to a caller having a plurality of contacts to be reached in a sequential plurality of two-way telephone conferences between the caller and at least a respective one of the plurality of contacts;

(b) upon establishing a caller connection between the telephony server and the caller, joining the caller connection to a conference bridge of the telephony server;

(c) initiating at least one second outgoing call to the at least the respective one of the plurality of contacts for which the respective two-way telephone conference is to be established;

(d) upon establishing in the at least one second outgoing call a respective contact connection between the telephony server and the respective at least one of the plurality of contacts, joining the respective contact connection to the conference bridge for the respective two-way telephone conference between the caller and the respective at least one contact, the conference bridge upon receiving respective signals from the caller connection and the at least one contact connection representative of audio signals by the caller and the respective at least one contact, mixes the signals thereof and distributes the mixed signals to the caller connection and the at least one contact connection;

(e) disengaging the at least one contact connection from the conference bridge upon disconnection of the second outgoing call by the respective at least one contact; and

(f) repeating steps (c)-(e) until the plurality of contacts have been engaged in the respective telephone conference between the caller and the at least one respective one of the contacts, then disengaging the at least one caller connection from the conference bridge.

In yet another aspect, the present invention provides a call center system for a caller to engage in a two-way telephone conference with a respective one of a plurality of contacts in sequence, comprising:

a telephony server configured for initiating a first outgoing call to a caller having a plurality of contacts to be reached in a respective two-way telephone conference with a respective one of contacts in sequence;

the telephony server further comprising a conference bridge, and upon establishing a caller connection with the caller, joining the caller connection to the conference bridge;

the telephony server, after joining the caller connection to the conference bridge, initiating a second outgoing call to a respective one of the plurality of contacts for which the respective two-way telephone conference is to be established;

upon establishing in the second outgoing call a contact connection between the telephony server and the respective one of the plurality of contacts, joining the contact connection to the conference bridge for the respective two-way telephone conference between the caller and the respective one contact, the conference bridge upon receiving respective signals from the caller connection and the contact connection representative of audio by the caller and the respective one contact, mixes the signals thereof and distributes the mixed signals to the caller connection and the contact connection;

disengaging the contact connection from the conference bridge upon disconnection of the second outgoing call by the respective one contact,

whereby the telephony server, being configured to continue imitating the respective second telephone calls in sequence, joins a subsequent contact connection to the conference bridge after disengaging the preceding contact connection, until the plurality of contacts have been engaged in the respective two-way telephone conference between the caller and the respective one of the contacts, then configured for disengaging the caller connection from the conference bridge.

The foregoing call center system may further comprise a determined status indicating the respective one contact meets one or more pre-determined criteria indicating a need for participation in the two-way telephone conference by a specialty participant; initiating through the telephony server in response to the determined status a third outgoing call to the specialty participant; and upon establishing a specialty participant connection between the telephony server and the specialty participant, the telephony server joining the specialty participant connection to the conference bridge of the telephony server, whereby the conference bridge upon receiving respective incoming signals from the connections, mixes the signals thereof and distributes the mixed signals as an outgoing signal to the connections.

Objects, advantages, and features of the present invention will become readily apparent upon a reading of the following detailed description in conjunction with the drawings and the appended claims.

### BRIEF DESCRIPTION OF THE DRAWINGS

FIG. 1 illustrates a schematic diagram of a call center apparatus for call center personnel to initiate, conduct and conclude telephone calls to contacts via a conferencing bridge in accordance with the present invention.

FIG. 2 illustrates a schematic diagram of the call center apparatus shown in FIG. 1 initiating and conducting call center telephone calls by a caller sequentially to contacts via a conferencing bridge.

FIG. 3 illustrates a schematic diagram of an alternate embodiment of a call center apparatus for call center personnel to initiate, conduct, refer and conclude telephone calls to contacts while involving a specialty participant for selected ones of the contacts via a conferencing bridge in accordance with the present invention.

FIG. 4 illustrates a schematic diagram of the alternate embodiment call center apparatus shown in FIG. 3 for initiating and conducting call center telephone calls by a sales development representative caller sequentially to contacts, and referring selected ones of the contacts to a specialty participant for further discussions via a conferencing bridge.

FIG. 5 illustrates a process in accordance with the present invention for initiating and conducting call center telephone calls by a sales development representative caller sequentially to contacts, and referring selected ones of the contacts to a specialty participant for further discussions via a conferencing bridge.

### DETAILED DESCRIPTION

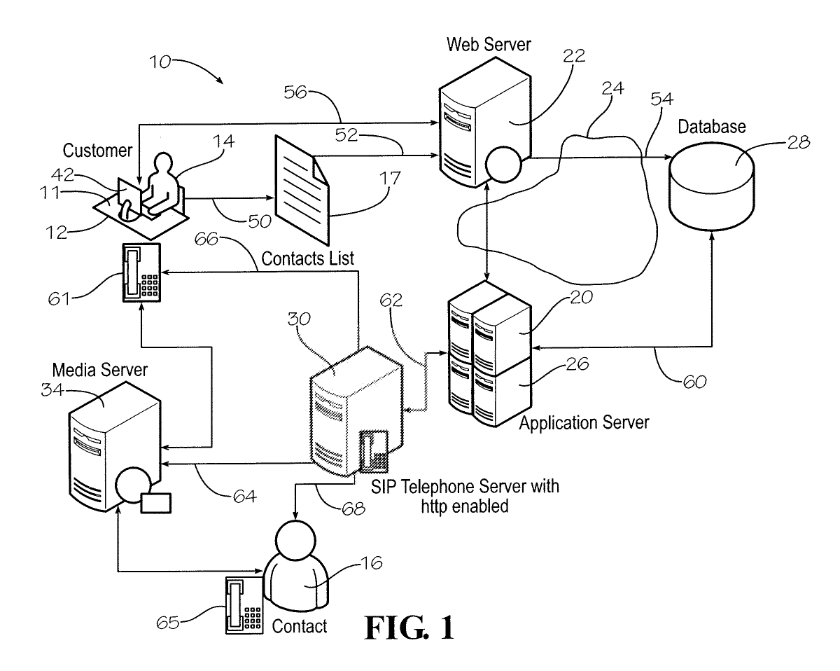

With reference to the drawings, in which like elements have like reference numerals, FIG. 1 illustrates a schematic diagram of an apparatus 10 for a call center 12 having a plurality of call center personnel 14 (also referenced herein as “caller”) to each initiate, conduct and conclude telephone calls to a plurality of contacts or persons 16 to whom a respective call is to be made. The contact persons 16 may include customers and prospective customers of goods and/or services being offered by the caller 14, or other persons for whom the caller is to contact (for example, a list of contact persons for a fund-raising program, a political outreach message to prospective voters, or other purpose for a contact or group of contacts to be made). The call center 12 may be an internal organization and activity of a company (for example, a sales center, a customer service center, reporting center, or other internal group) or may be an independent call center providing contract call center services to third parties and on behalf of third parties using scripts, information, and contact information supplied by the third party. The caller 14 obtains, or generates according to particular criteria, a list 17 of the contacts 16 for which the telephone call is to be made.

The illustrated embodiment uses an application server 20 configured as a software-as-a-service provider having a computer software application executing software instructions for facilitating, coordinating, and directing the activities of the operation of the call center and its calling/contact services. A web server 22 connects through a network 24 (such as the world wide web) with the application server 20. A customer relations management (CRM) system 26 (or computer application), such as SALESFORCE systems, maintains a customer information database 26. The customer relations management (CRM) system 26 in the illustrated embodiment is installed on the application server 20. The CRM system may be accessed through the network 24. Alternatively, the CRM system 26 may be installed on the web server 22 or other customer computer center for access by the caller 14 and the application server 20 to the database 26.

The application server 20 communicates with a telephony server 30. In the illustrated embodiment, the telephony servicer 30 is configured for session initiation protocol (SIP) for establishing two-way telephonic sessions between the caller 14 and the contact 16, and operatively interacting for telephonic sessions between the caller and the contact, as discussed below. Oracle BEA SIP Servlet system provides an SIP telephony communications system useful for configuring in accordance with the present invention.

A media server 34 provides a plurality of available media files for selective use by the caller 14 during the telephone call with the contact 16. These media files may include pre-recorded messages or information responsive to a question or issue being discussed by the caller and the contact. A DIALOGIC media system may be configured for use in accordance with the present invention.

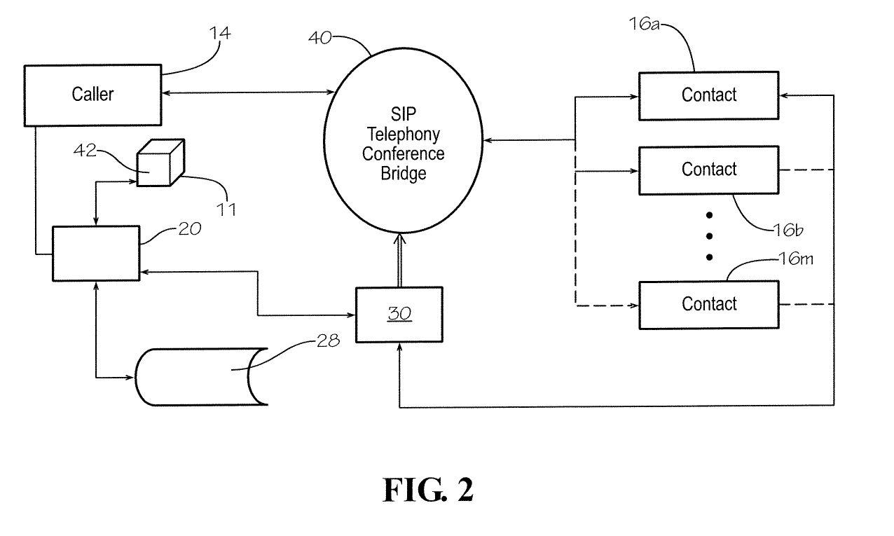

FIG. 2 illustrates a schematic diagram of the apparatus 10 initiating and conducting call center telephone calls by the caller 14 to each one of the contacts 16a, 16b, . . . , 16n sequentially via a teleconference bridge 40. In the illustrated embodiment, the call center application instructs the SIP telephony application to create the teleconference bridge 40, or essentially, an electronic communications conference room, that incorporates two-way communications between the conference room and the caller 14 and the one or more contacts 16 each connected to the teleconference bridge 40. During operation, the SIP telephony application first establishes electronic two-way communication with the caller 14. Generally, this is accomplished after the caller 14 directs the application to commence a calling sequence using the identified list 17 of contacts 16. Alternatively, the caller 14 is provided the list 17 upon initiation of a work cycle of the call center.

During operation, the bridge 40 is open for two-way communications with the caller 12. When ready, the caller 14 signals the application to open a communications channel with one of the contacts 16. The SIP telephony application then places a telephone call to the contact 16 and joins that telephone call to the bridge 40. The caller 14 then hears the signaling of the call to the called contact. If the contact answers, the caller 14 is available immediately to begin presenting or discussing the subject matter of the call. If the contact does not answer, the caller 14 may cause the application to disconnect the communication link with the called contact. Alternatively, if the called contact has a voice mail or message system intercept, the caller 14 may signal for the media server 34 to provide to the conference bridge 40 a pre-recorded message. The audio signal of the message communicates from the bridge 40 to the caller 14 and the contact 16 for being recorded by the contact's voice mail or message system. The caller then causes the application to disconnect the communication link with the called (but non-answering) contact. The application then may automatically initiate a telephony connection with the next contact 16 in the list 17. The caller 14 remains electronically connected for two-way communication. The application joins the new communication link to the bridge, and the caller 12 then hears the signaling of the call to the called contact.

During the calling process, the application extracts from the database 28 appropriate contact information relevant to the subject matter of the conference call and presents the information on a display screen 42 viewable by the caller 14. This information may include, for example, account information, address, notes of prior conferences, status information, product information (serial number, specification, product type, and other related information) and other information maintained in the CRM database.

With reference to FIG. 1, the caller 14 operates a microprocessor work station 11 having information input devices (keyboard, mouse, touch-sensitive display screen, bar-code reader, or other input devices), the display screen 42 and communications devices for accessing the network. The caller 14 creates 50 the contact list 17, for example using the customer relations management (CRM) system 26. Alternatively, the list 17 is provided by a manager of the group 12 of callers 14. The caller 14 submits 52 the contact list 17 to the database 28 through the web server 22. The web servicer 22 communicates 54 the contact list 17 through the network 24 to the database 28. The caller 14 begins 56 the dialing session from the application 20 integrated with the CRM system 26. The web server 22 notifies 58 the application server 20 of the request for the dialing session.

The application 20 establishes a two-way web communication session with the caller 14. The two-way communication session between the web server 22 and the application server 20 enables status updates to the database 28. The communications link also allows presentation on the screen 42 of the caller 14 of updates to the information, enables creating and storing notes made during and regarding the call, call or issue dispositions, as well as call control.

The application server 20 obtains 60 the list from the database 28 and establishes the two-way session for updating the call status to the database.

The application server 20 instructs the SIP Telephony server 30 (over its http access) to place a call to the telephone 61 of the caller 14.

The SIP telephony server 30 also establishes 62 a two-way communication session with the application server 20 to return call statuses and receive further instructions. SIP Telephony server 30 then establishes 64 a communications session with the media server 34. The SIP telephony server 30 also creates the conference bridge 40.

The telephony server 30 then places 66 the call to the caller 14 (sales agent) and invites his telephone 61 to join the conference bridge 40. The telephony server 30 then reports the status back to the application server 20.

The caller's phone 61 joins the conference bridge 40 with the media server 34 and waits for the application to dial out to the contacts 16 to connect with at least a respective one of the contacts 16.

On a successful response from the telephony server 30 that the caller 14 is connected to the conference bridge 40, the application server 20 instructs the telephony server 30 to dial the contact 16. The application server 20 also sends the call status and the contact's information to the web server 22 which in turn communicates with the caller's desk system to update the information about the contact presented on the display screen 42.

The telephony server 30 dials 68 the contact's telephone 65 and invites the call to join the same conference bridge 40 that the caller 14 (sales agent) is waiting on. The telephony server 30 reports the status back to the application server 20 which in turn updates the database 28, and communicates through the web server 22 to provide updated information for display on the caller's screen 42.

The contact's phone 65 joins the conference bridge 40 and the caller 14 (sales agent) and the contact 16 can start talking immediately. There is no delay as the contact 16 says “hello” or other opening greeting as typical when first answering an incoming call. The contact 16 is immediately present on the call because of the conference room created by the conference bridge 40 with two-way communication of all joined in the conference bridge. The caller 14 responds appropriately to the contact's hello, such as with the script provided for the caller to work from.

While the dialing session is going on, the caller 14 does not need to hang up his phone line. The contact 16 may make notes that communicate through the web server 22 to the database 28. When the contact 16 hangs up or disconnects on his own, the telephony server 30 detects the hang up and sends the information to the application server 20.

The calling and joining steps are then repeated for the contacts 16 in sequence. The telephony server 30 dials 68 the telephone 65 of the next contact 16 on the list 17 and invites the call to join the same conference bridge 40 that the caller 14 (sales agent) is continuing on. The calling, joining, and disconnecting of the respective calls to the contacts 16 sequentially repeats until all the contacts in the list have been called. Contacts 16 for which no answer was received (and thus not joined to a conference bridge call) may be placed at the end of the list for a follow-up call during the caller's dialing session. Alternatively, no-answer contacts are memorialized in a note maintained in the database 28 for further consideration and action.

At the end of the caller's list, the application server 20 instructs the SIP telephony server 30 to end the telephony session and end the dialing campaign. In the event the caller 14 disconnects such as by mistake or other need, the telephony sever 30 detects the disconnect and updates the application server. The SIP telephony server 30 the re-starts the calling campaign by placing 66 the call to the caller 14 (sales agent) and inviting his telephone 61 to join the conference bridge 40. Once the caller 14 joins the conference bridge 40, the telephony server 30 dials 68 the telephone 65 of the next contact 16 on the list 17 and invites the call to join the same conference bridge 40 that the caller 14 (sales agent) is continuing on.

The caller 14 (sales agent) also has control in the application 20 to end the contact's call leg, record the call, and play pre-loaded voice messages from the media server 34 to a contact's voicemail. The data flow path is similar to what is described, except that instead of starting calls, the telephony and media servers are instructed to either end a call, record a call or play a specified voicemail.

An alternate embodiment provides direct click-to-dial functionality which follows a similar path, except that such calls ends the caller 14 (sales person) call leg along with the contact 16 call leg after every call.

The application 20 monitors and constantly requests the web server 22 for updated statuses of the calls in order to update the CRM system 26 and database 28 with which the application is integrated.

The apparatus 10 and method of bridging caller and contacts as disclosed herein provides improved efficiency for caller (sale representative) in sales activity on behalf of clients seeking to reach out to contact customers and prospective customers for the sale and purchase of the client's goods and services. The apparatus and method further improves efficiency in reaching out to customers for support services. The apparatus and method may be applied gainfully not only with outbound calls as disclosed and described herein, but with inbound calls from contacts as well.

The telephony application 30 accordingly makes two outbound calls to join first the caller 14 to the conference bridge 40 and second to join the call to the contact 16, but to the caller 14, the apparatus appears to have made just one call (to the contact 16), with subsequent contacts 16 called in sequence without disconnection of the caller 14. The apparatus and method provides improved connection speed (the contact 16 is immediately speaking with the caller 14) and increased transparency of communication between the caller and the contact. The apparatus provides automated connection (joining) of calls with a plurality of contacts sequentially through a telephony server configured to establish a conference bridge, join a caller connection to the conference bridge, and join a contact connection to the conference bridge, and provide two-way communications between the connections joined to the conference bridge, while in the background updating the CRM database 28 including caller notes, time and date of the call, duration, and other useful management tracking information, which conference bridge is a mixer configured to receive audio signals from the caller connection and the contact connection, mix the audio signals thereof, and distribute the mixed audio signals to the caller and the contact joined in the conference bridge.

More particularly, the apparatus disclosed herein provides automated connection (joining) of calls by a caller with a plurality of contacts sequentially through a telephony server having a conference bridge, a first connection joined to the conference bridge, and at least one second connection selectively joined to the conference bridge from a plurality of second connections with each of the plurality of second connections selectively joined following disconnection of a preceding second connection while maintaining the first connection, for two-way communications between the first connection and the at least one second connection joined to the conference bridge in sequence, which conference bridge receives audio signals from the first connection and the at least one second connection, mixes the audio signals thereof, and distributes the mixed audio signals to the first connection and the at least one second connection joined in the conference bridge.

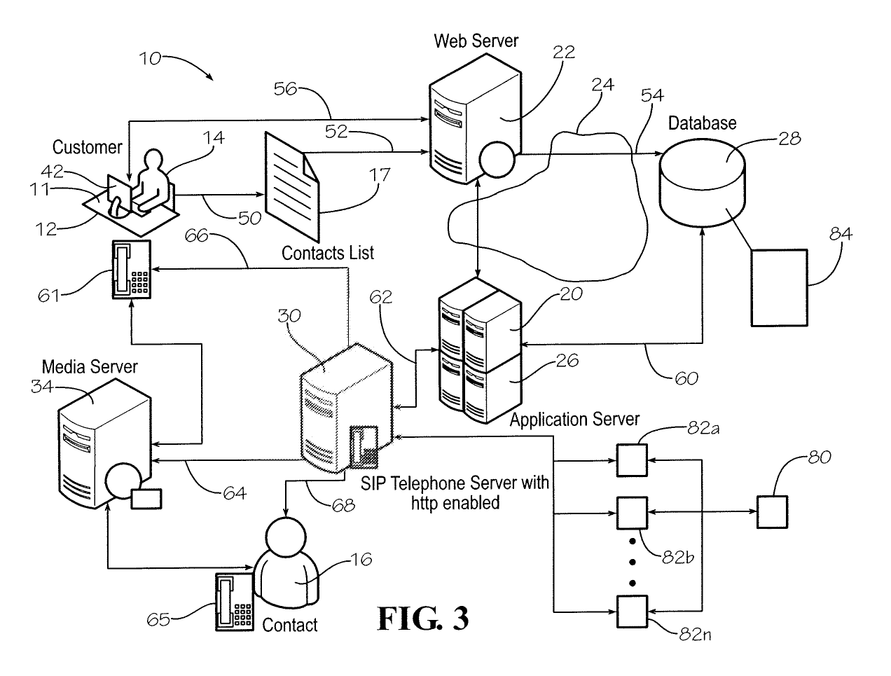

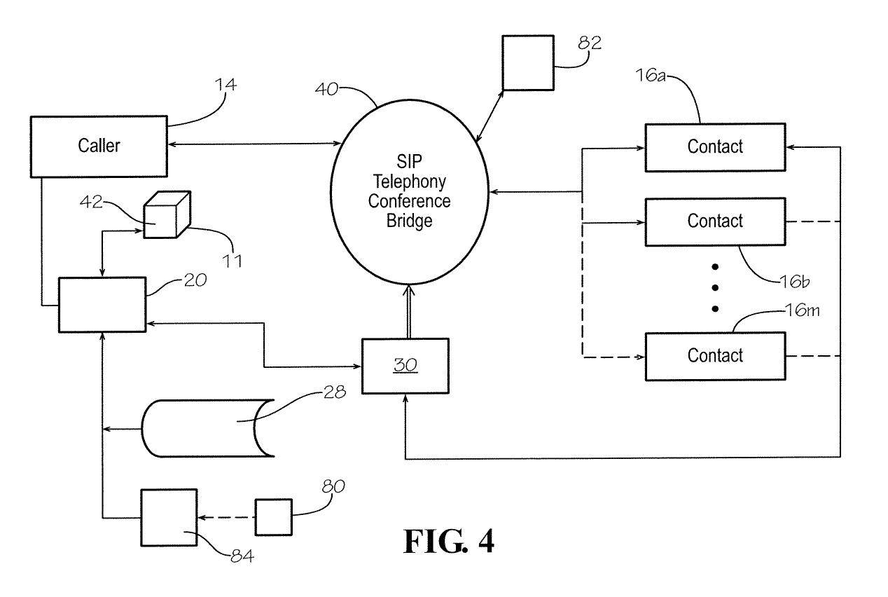

FIG. 3 illustrates a schematic diagram of an alternate embodiment of a call center apparatus for call center personnel to initiate, conduct, refer and conclude telephone calls to contacts while involving a specialty participant for selected ones of the contacts via a conferencing bridge in accordance with the present invention. FIG. 4 illustrates a schematic diagram of the alternate embodiment call center apparatus shown in FIG. 3 for initiating and conducting call center telephone calls by a sales development representative caller sequentially to contacts, and referring selected ones of the contacts 16 to a specialty participant for further discussions via a conferencing bridge. This embodiment is particularly configured for a company with a sales department 80 having a plurality of specialty participants or dedicated sales representatives 82 knowledgeable in company products and services and skilled in closing sales as the specialty participant, with a sales development department having the plurality of callers 14 and the plurality of customer contacts 16. The sales development department 12 may be in-house with the company, or alternatively, provided through a third party call center servicing the company. The company establishes a plurality of pre-determined criteria 84, which criteria is provided to the caller 14 for evaluation of the contact 16 during screening discussions. Typically, the sales development caller 14 makes a large number of outbound calls to the various contacts 16 as indicated on the contacts list 17, in accordance with the call center system 10 discussed above. For example, the caller 14 may be calling the contacts to schedule appointments for the personnel 82 of the sales department 80.

During interaction of the caller 14 and the contact 16 on the SIP conference bridge 40, the caller 14, or the application server 20 configured for assessing whether the contract 16 satisfies the pre-determined criteria, evaluates the contact 16 relative to the pre-determined criteria 84. This criteria may include, but is not limited to, contact's expressed need for short-time purchase and delivery of goods or services, credit issues, quality concerns, competitive quotes, or other subjects for which a specialty participant may be important in the discussion. The caller 14 or the application server 20 may determine that the contact 16 is of current importance or “qualified” as meeting the pre-determined criteria 84 and should be placed in communication with the sales department 80 and one of its sales representatives 82. The sales representative operates one of the microprocessor work station 11 having information input devices (keyboard, mouse, touch-sensitive display screen, bar-code reader, or other input devices), the display screen 42 and communications devices for accessing the network.

In accordance with the present invention, the SIP telephony conference bridge 40 is configured for engaging the contact 16 with one of the sales representatives 82. This is accomplished by the caller 14 or application 20 signaling the SIP conferencing bridge 40. The SIP conferencing bridge 40 initiates a new call to one of the sales representatives 82. The called sales representative 82 is joined to the bridge 40. In the illustrative embodiment, the caller 14 provides appropriate contact information to the sales representative 82 as to the qualification of the contact pursuant to the criteria 84. Alternatively, the information about the contact 16 is presented on the screen of the microcomputer/communications system of the sales representative 82. The sales representative may then quickly develop an understanding of the contact and needs and the basis for the caller 14 (or application server 20) determining that the sales representative should be brought into the discussion on the bridge 40. The bridge 40 then connects the sales representative 80 with the contact 16 and disengages the caller 14 from the bridge 40. The calling system 10 then initiates a new bridge 40 and connects the caller 14 to the new bridge. The caller 14 signals that the next contact on the list 17 should be contacted. The caller 14 thus continues with the new contact 16 as discussed above with respect to FIGS. 1 and 2.

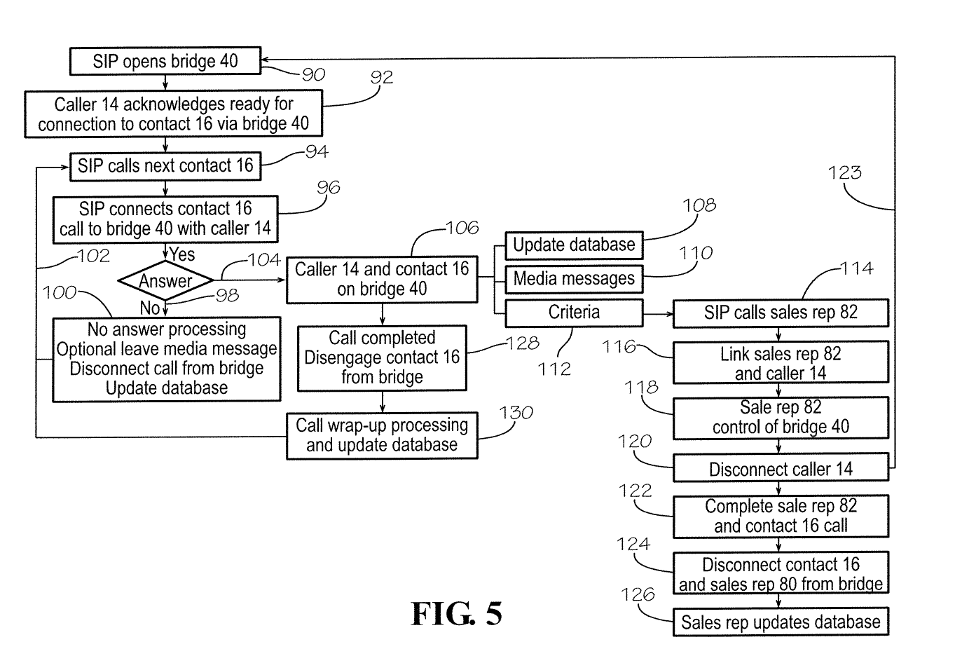

FIG. 5 illustrates a process in accordance with the present invention for initiating and conducting call center telephone calls by the sales development representative caller 14 sequentially to the plurality of contacts 16 pursuant to the contacts list 176, and referring selected ones of the contacts 16 to a specialty participant such as one of the sales representative 80 for further discussions via the conferencing bridge 40. The application server 20 opens 90 the communications bridge 40 and initiates an outgoing call to the caller 14. The caller 14 acknowledges 92 a ready state for receiving contact information and calls of the contacts 16 on the list 17. The bridge 40 makes the outgoing call 94 the next contact 16. The bridge connects 96 the call to the contact 16 to the bridge 40 to join the caller 14 on the bridge. As discussed above, if the contact does not answer 98 the call, the caller 14 enters “no answer” processing 100, such as optionally leaving a prerecorded message. The bridge disconnects the call to the contact 16. The caller 14 updates the database. The caller 14 signals 102 the bridge the ready state for receiving a call from a subsequent contact 16.

As discussed above, if the contact answers 104 the call, the caller 14 commences the subject matter processing and discussion 106 with the contact 16 through the bridge 40. This includes, as discussed above, the updating 108 of the database as appropriate and presentation 110 of appropriate media messages. The present invention may further include an evaluation 112 as to whether the contact 16 meets the pre-determined criteria 84 that leads to involvement of the specialty personnel (such as the sales representative 82). The evaluation may be made by the caller 14 as part of sales development responsibilities, or alternatively, may be made by the application server configured for evaluating the information about the contact as recorded on the data records of the database. Depending on the particular configuration, the application service 20 may signal a suggestion to the caller 14 that further participation by the specialty participant 82 is indicated, or may alternative, advise the caller 14 that a specialty participant 82 is being contacted for participation in the bridge call. That provides opportunity for the caller 14 to advise the contact 16 that a specialty participant would become involved for responding to the needs or subject matter raised during the discussion with the contact 16.

The bridge 40 initiates 114 a third outgoing call to a sales representative 82. The bridge 40 connects 116 the sales representative 82 into the call with the caller 14 and the contact 16. The bridge may selectively join the caller 14 and the sales representative 82 privately with communications to and from the contact 16 muted. The display screen 42 of each of the caller 14 and sales representative 82 preferably displays a signal as to the communication status. When signaled that the specialty participant is ready, the bridge joins the calls of the sales representative, the caller, and the contact. The sales representative 82 may signal 118 control of the bridge call. The bridge 40 disconnects 120 the caller 14. The application server 20 determines 123 that the caller 14 is disconnected from bridge, and establishes 90 a new bridge 40 for the caller 14, for continuing the calls to other contacts on the list 17.

The specialty participant 82 continues 122 the bridged call with the contact 16. When the call is completed 124, the bridge 40 disconnects the calls to the contact 16 and to the sales representative 82. The sales representative 82 updates 126 the database as appropriate. The sales representative 82 then signals the application server 20 a ready state for receiving a subsequent specialty participant bridge call.

If the caller 14 (or application server 20 if so configured), does not determine that the contact or the subject matter of the bridged call requires specialty participant involvement, the call proceeds. Upon completion 128, the bridge disconnects the contact 16 and the caller attends 130 to database updates as appropriate. Upon completion, the caller 14 signals 102 the bridge 40 the ready state for receiving a call from a subsequent contact 16.

The invention accordingly facilitates involvement of specialty participants at the time of the live connection with the contact 16 rather than deferring responsive discussion to a subsequent call and discussion, which may lead to increased sales and increased contact satisfaction with the subject matter of the call. The present invention is further gainfully beneficial in other call-center applications not limited to setting appointments and sales, but for example, a technical support center for computer or equipment support, a loan servicing center, accounts servicing (for example, credit accounts and payment servicing, utility billing services, and services providing companies such as insurance product providers), in which matters of discussion may be subject to criteria by which it may be determined that involvement by a specialty participant is appropriate. The apparatus and method accordingly coordinates placing of outgoing calls to the caller 14 and contact 16, joining the outgoing calls in the bridge 40 for communication, evaluates whether specialty participants are indicated as appropriate, placing of a third outgoing call to such specialty participant, and releasing the caller to a new bridge process for continuing productive use of time and resources.

It is to be appreciated that computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The call center calling apparatus and method can be a component of a single system, multiple systems, and/or geographically separate systems. The call center calling apparatus and method can also be a subcomponent or subsystem of a single system, multiple systems, and/or geographically separate systems. The call center calling components can be coupled to one or more other components (not shown) of a host system or a system coupled to the host system.

One or more components of the call center calling apparatus and method and/or a corresponding interface, system or application to which the call center calling apparatus is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistant devices, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the call center calling apparatus and method can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include but are not limited to, removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the call center calling apparatus and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the c call center calling apparatus and method and corresponding systems and methods include: microcontrollers with memory (such as electronically erasable programmable read only memory (EEPROM)), embedded microprocessors, firmware, software, etc. Furthermore, aspects of the call center calling apparatus and method and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the call center calling apparatus and method and the corresponding systems and methods is not intended to be exhaustive or to limit the systems and methods to the precise forms disclosed. The elements and actions of the various embodiments described above can be adapted, modified and combined to provide further embodiments in accordance with the present invention of the call center calling apparatus and methods and corresponding systems and methods in light of the above detailed description. While specific embodiments of, and examples for, the call center calling apparatus and method and corresponding systems and methods are described herein for illustrative non-limiting purposes, various equivalent modifications are possible within the scope of the systems and methods, as those skilled in the relevant art will recognize. The teachings of the call center calling apparatus and method and corresponding systems and methods provided herein can be applied to other systems and methods, not only for the systems and methods described above. Moreover, those skilled in the art may make modifications, variations and changes thereto without departure from the spirit and scope of the invention as described by the following claims.

What is claimed is:

1. A method of operating a call center for conducting two-way telephone conferences between a caller and a plurality of contacts in sequence, comprising the steps of:
(a) initiating through a telephony server a first outgoing call to a caller having a plurality of contacts to be reached in a sequential plurality of two-way telephone conferences between the caller and at least a respective one of the plurality of contacts;
(b) upon establishing a caller connection between the telephony server and the caller, joining the caller connection to a conference bridge of the telephony server;
(c) initiating at least one second outgoing call to the at least the respective one of the plurality of contacts for which the respective two-way telephone conference is to be established;
(d) upon establishing in the at least one second outgoing call a respective contact connection between the telephony server and the respective at least one of the plurality of contacts, joining the respective contact connection to the conference bridge for the respective two-way telephone conference between the caller and the respective at least one contact, the conference bridge upon receiving respective signals from the caller connection and the at least one contact connection representative of audio signals by the caller and the respective at least one contact, mixes the signals thereof and distributes the mixed signals to the caller connection and the at least one contact connection;
(e) disengaging the at least one contact connection from the conference bridge upon disconnection of the second outgoing call by the respective at least one contact; and
(f) repeating steps (c)-(e) until the plurality of contacts have been engaged in the respective telephone conference between the caller and the at least one respective one of the contacts, then disengaging the at least one caller connection from the conference bridge.

2. The method as recited in claim 1, further comprising the steps of:
determining by the caller that the respective one contact meets one or more pre-determined criteria indicating a need for participation in the two-way telephone conference by a specialty participant;
signaling the telephony server to call the specialty participant;
initiating through the telephony server a third outgoing call to the specialty participant; and
upon establishing a specialty participant connection between the telephony server and the specialty participant, joining the specialty participant connection with the specialty participant to the conference bridge of the telephony server,
whereby the conference bridge upon receiving respective incoming signals from the connections, mixes the signals thereof and distributes the mixed signals as an outgoing signal to the connections.

3. The method as recited in claim 2, further comprising that upon joining the specialty participant connection to the conference bridge, disengaging the caller connection from the conference bridge.

4. The method as recited in claim 3, further comprising the step of engaging the caller connection to a second telephone bridge.

5. A call center system for a caller to engage in a two-way telephone conference with a respective one of a plurality of contacts in sequence, comprising:
a telephony server configured for initiating a first outgoing call to a caller having a plurality of contacts to be reached in a respective two-way telephone conference with a respective one of contacts in sequence;
the telephony server further comprising a conference bridge, and upon establishing a caller connection with the caller, joining the caller connection to the conference bridge;
the telephony server, after joining the caller connection to the conference bridge, initiating a second outgoing call to a respective one of the plurality of contacts for which the respective two-way telephone conference is to be established;
upon establishing in the second outgoing call a contact connection between the telephony server and the respective one of the plurality of contacts, joining the contact connection to the conference bridge for the respective two-way telephone conference between the caller and the respective one contact, the conference bridge upon receiving respective signals from the caller connection and the contact connection representative of audio by the caller and the respective one contact, mixes the signals thereof and distributes the mixed signals to the caller connection and the contact connection;
disengaging the contact connection from the conference bridge upon disconnection of the second outgoing call by the respective one contact,
whereby the telephony server, being configured to continue imitating the respective second telephone calls in sequence, joins a subsequent contact connection to the conference bridge after disengaging the preceding contact connection, until the plurality of contacts have been engaged in the respective two-way telephone conference between the caller and the respective one of the contacts, then configured for disengaging the caller connection from the conference bridge.

6. The call center system as recited in claim 5, further comprising:
a determined status indicating the respective one contact meets one or more pre-determined criteria indicating a need for participation in the two-way telephone conference by a specialty participant;
initiating through the telephony server in response to the determined status a third outgoing call to the specialty participant; and
upon establishing a specialty participant connection between the telephony server and the specialty participant, the telephony server joining the specialty participant connection to the conference bridge of the telephony server,
whereby the conference bridge upon receiving respective incoming signals from the connections, mixes the signals thereof and distributes the mixed signals as an outgoing signal to the connections.

7. The call center system as recited in claim 6, further comprising that upon joining the specialty participant connection to the conference bridge, disengaging the caller connection from the conference bridge.

8. The call center system as recited in claim 7, wherein the telephony server further configured for joining the caller connection to a second telephone bridge after joining the specialty participant connection to the conference bridge.

9. An apparatus configured for automated joining of calls by a caller with a plurality of contacts sequentially through a telephony server having a conference bridge, a first outgoing call to the caller to establish a first connection and joined to the conference bridge, and at least one second outgoing call to a contact from a plurality of contacts to establish a second connection and joined to the conference bridge, with each of the plurality of second connections selectively joined following disconnection of a preceding second connection while maintaining the first connection, for two-way communications between the first connection and the at least one second connection joined to the conference bridge in sequence, which conference bridge receives audio signals from the first connection and the at least one second connection, mixes the audio signals thereof, and distributes the mixed audio signals to the first connection and the at least one second connection joined in the conference bridge.

10. The apparatus as recited in claim 9, further comprising caller determining that the contact meets a pre-determined criteria for participation in the conference bridge by a specialty participant, and upon signaling by the caller, a third outgoing call to the specialty participant to establish a third connection and joined to the conference bridge.

11. The apparatus as recited in claim 10, wherein the first connection disconnected from the conference bridge after joining the specialty participant.
